(19) United States
(12) Patent Application Publication
(10) Pub. No.: US 2014/0331912 A1
(43) Pub. Date: Nov. 13, 2014

(54) APPARATUS USING AN ELECTRO-CATALYTIC COATING TO REDUCE SHIP'S FRICTION AND PREVENT BIOFOULING

(71) Applicants: KEE-RONG WU, KAOHSIUNG CITY (TW); YU-TSUEN SHYU, KAOHSIUNG CITY (TW); CHUNG-HSUANG HUNG, KAOHSIUNG CITY (TW); JIING-KAE WU, TAINAN CITY (TW); CHIUNG-WEI YEH, KAOHSIUNG CITY (TW); SHUN-HSYUNG CHANG, TAIPEI CITY (TW)

(72) Inventors: KEE-RONG WU, KAOHSIUNG CITY (TW); YU-TSUEN SHYU, KAOHSIUNG CITY (TW); CHUNG-HSUANG HUNG, KAOHSIUNG CITY (TW); JIING-KAE WU, TAINAN CITY (TW); CHIUNG-WEI YEH, KAOHSIUNG CITY (TW); SHUN-HSYUNG CHANG, TAIPEI CITY (TW)

(21) Appl. No.: 14/265,497

(22) Filed: Apr. 30, 2014

(30) Foreign Application Priority Data
May 7, 2013 (TW) 102116147
May 7, 2013 (TW) 102116229

(51) Int. Cl. C09D 5/16; B63B 1/38

(52) U.S. Cl. CPC C09D 5/1693; B63B 1/38; B63B 2001/387
USPC 114/67 A; 252/514; 252/512; 423/385; 428/457; 428/334

(57) ABSTRACT

An apparatus for friction reduction and biofouling prevention is invented, which consists of an anodic electro-catalytic layer and a cathodic electro-catalytic layer installed on the submerged surface of a carrier. There is an insulating filling between the anodic layer and the cathodic layer. The layered coatings are applied with the use of electric arc spraying technique. A first DC power supply unit is connected to the anodic layer and the cathodic layer. The anodic layer, the cathodic layer, the DC power supply unit, and water together form the conducting path for water electro-catalysis. Hydrogen and oxygen gases are produced to form a thin gas film on the submerged surface to reduce friction and prevent biofouling on the carrier. Alternatively, the apparatus produces hydroxyl radicals to kill marine microorganisms and reduce the risk of biofouling and biocorrosion.

### BACKGROUND

This invention concerns a layered coating and an apparatus with electro-catalytic ability for reducing ship's friction and preventing biofouling on submerged structures.

Due to the gradual exhaustion of fossil fuels, the increasing fuel price is harsh to shipping companies worldwide. The increase of fuel consumption results from the frictional resistance and biofouling on the submerged hull of a moving ship.

In the conventional approach of using micro-bubbles to reduce frictional resistance, compressed air is pushed by a blower to pass through porous plates located on the submerged hull. Micro-bubbles are then continuously generated on the outer surface of the submerged hull to reduce the frictional resistance on the sailing ship. The porous plates are usually located adjacent to the bow or where optimal reduction of frictional resistance can be obtained. The calculated friction reduction can be as high as 80%. But the friction reduction realized by this technique on a mid-sized ship was less than 2%. according to a recent field study. Reasons for such a tremendous difference could be the following.

1. The air bubbles generated are so large that they impede with each other, and become even larger due to buoyancy. Besides, the air bubbles rise by buoyancy instead of staying with the submerged hull surface.
2. The location of the porous plates is such that the generated air bubbles do not effectively cover the submerged hull.
3. When the air blow rate is increased, the bubbles pass through the porous plates with higher velocities and move away from the outer surface of the submerged hull.

Meanwhile, the submerged hull is apt to form a layer of microorganisms via the process of conditioning, aggregation, colonization and growth. Barnacles, algae, seaweeds, weeds, carssostrea gigas, hydroides, bivalves, etc. are attracted and reside on the layer of microorganisms, rendering an increase in the roughness of the submerged hull surface. The overall weight of the hull can be increased by up to 75%, leading to a severe decrease of ship speed. Taking a ship under severe biofouling and sailing with a speed of 15 nautical miles per hour (i.e., 15 knots), the frictional resistance of the ship may be increased by up to 80% and the fuel consumption may be increased by up to 86%. This significantly increases the shipping cost. Furthermore, the marine organisms adhered to the submerged hull surface potentially increase the risk of biocorrosion of the steel hull and may even cause hazard to sailing stability and safety.

Adherence of marine organisms on the submerged hull is conventionally resolved by mechanical removal, antifouling painting, and electrochemical antifouling. Mechanical removal is economically inefficient because it requires considerable labor and time to periodically remove the resided marine creatures from the hull surface. Antifouling painting is a sprayed coating on the submerged hull, primarily containing copper, mercury, and arsenic substance, which continuously kill marine creatures. The state-of-the-art antifouling paint has a quite long service life of up to five years, and the painting technique brings long-term cost-effective results. However, the toxic substances in the antifouling coating would permeate into the seawater and cause damage to marine ecology. Thus, many European countries have forbidden the use of toxic antifouling paint since 2008.

Alternatively, electrochemical biofouling coating generates chloride ions and chlorine through electrolyzing the seawater, which kill the bacteria, spores and larvae in the seawater and inhibit them from residing on the submerged hull. However, free chlorine is a strong oxidizer which not only causes corrosion of the steel hull but also hurts other near-by marine creatures (such as fish and clams). Thus, the technique potentially destroys the marine ecological chain in the surrounding seawater.

### SUMMARY OF THE INVENTION

The invention provides an apparatus and a layered coating, preferably by electric arc spraying technique, for the generation of electro-catalytic gases to reduce friction and to prevent biofouling for a submerged structure such as a ship. The apparatus consists of an anodic layer and a cathodic layer, which are electrically separated and coated on the outer surface of the submerged hull of a ship or an underwater structure. A DC power supply unit is connected to the layers. The anodic layer, the cathodic layer, the DC power supply unit and the surrounding seawater form a conducting path for the electro-catalytic evolution of hydrogen and oxygen gases. Contrary to other known micro-bubble friction reduction methods, the evolved gases form a thin gas film, or a hydrophobic surface, on the submerged hull, and the frictional resistance of sailing is reduced. In addition, the electric current along the coating significantly reduces the attachment of marine creatures, such as barnacles, algae, seaweeds, weeds, carssostrea gigas, hydroids, and bivalves to the outer surface of the submerged hull sailing at speeds below five knots, which is the range of speeds marine creatures can reside.

To possess electro-catalytic property, the materials of the coating are selected among titanium oxide doped with ruthenium, titanium oxide mixed with manganese, titanium oxynitride, and titanium oxide mixed with bismuth.

The invention will become clearer in light of the following detailed description of the drawings.

### DESCRIPTION OF DRAWINGS

FIG. 1 shows a ship with the invented coatings applied on its submerged hull.

FIG. 2 is a cross-sectional view of the ship hull A-A in FIG. 1.

FIG. 3A is an enlarged view of the circle E in FIG. 2.

FIG. 3B is an enlarged view of the circle G in FIG. 2.

FIG. 3C is an enlarged view of the circle F in FIG. 2; an example of three-layered electro-catalyst.

FIG. 3D is an example of two-layered electro-catalyst.

FIG. 4A is a schematic view of the sea chest of a ship according to a prior art.

FIG. 4B is an enlarged view of the sea chest (circle H) in FIG. 2.

### DETAILED DESCRIPTION OF THE INVENTION

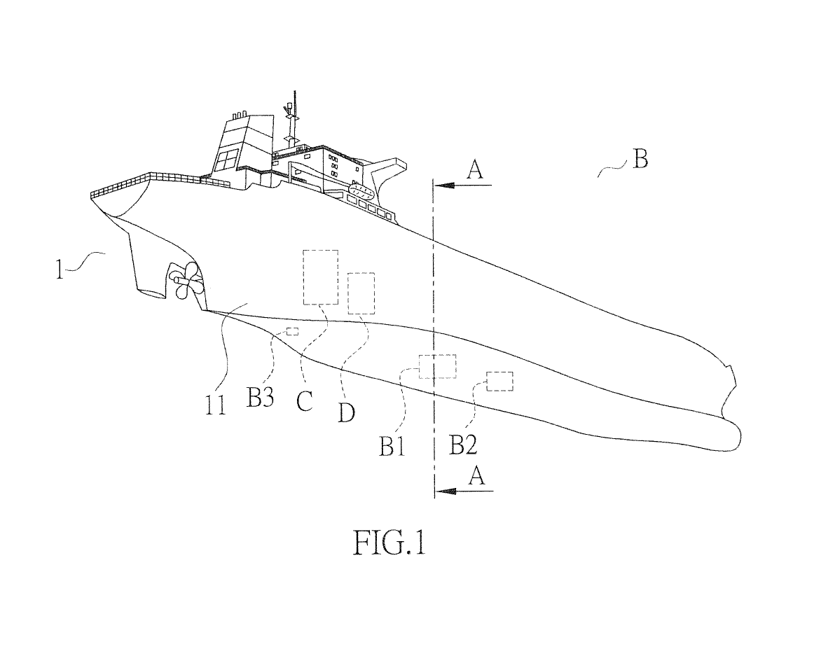

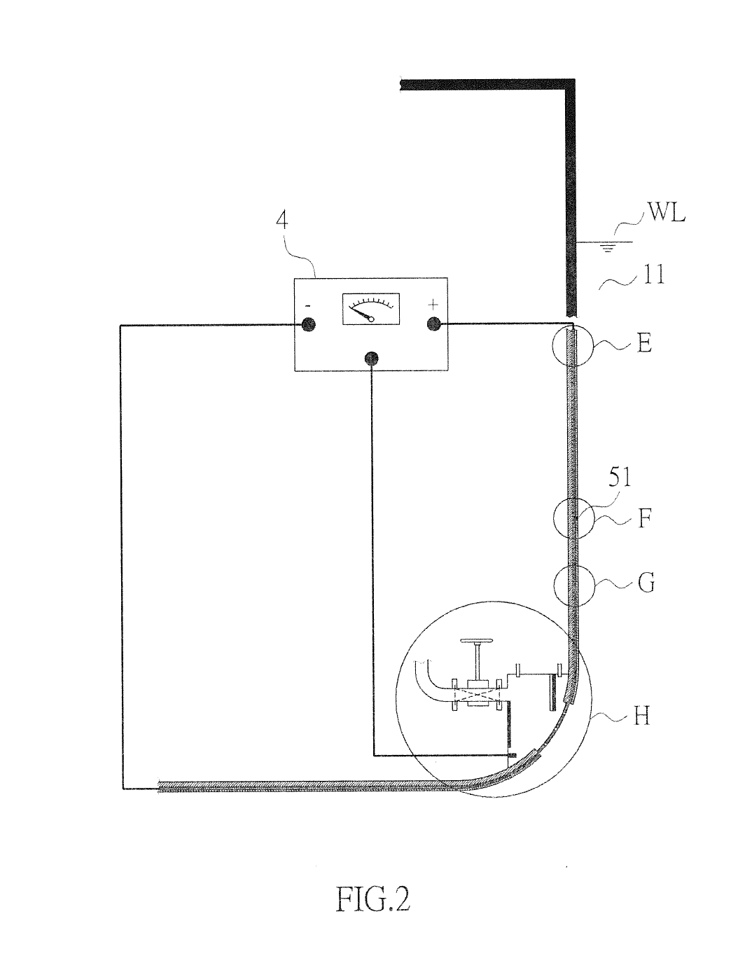

With reference to FIGS. 1 and 2, the invention provides an apparatus of friction reduction and biofouling prevention for the submerged portion of a carrier or maritime structure. The submerged portion can be the submerged hull 11 of a ship B, of an oil rig, of a wind power generator platform, or of a wharf. The term “submerged portion” means that portion of the carrier below the water line WL. In FIG. 1 the submerged portion of the carrier is the submerged hull 11 of a ship B, and the term “hull 11” will be used hereafter to indicate that portion of the hull 11 below the water line WL. FIG. 2 shows the general arrangement of the invention. The embodiment of the invention will be given in terms of water (preferably seawater) electro-catalysis.

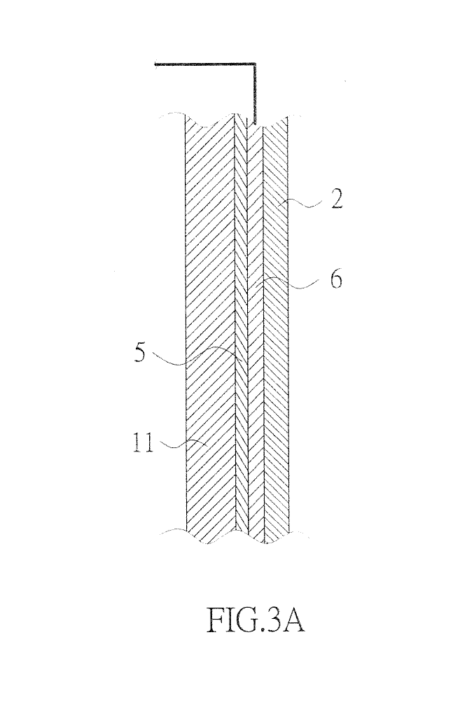

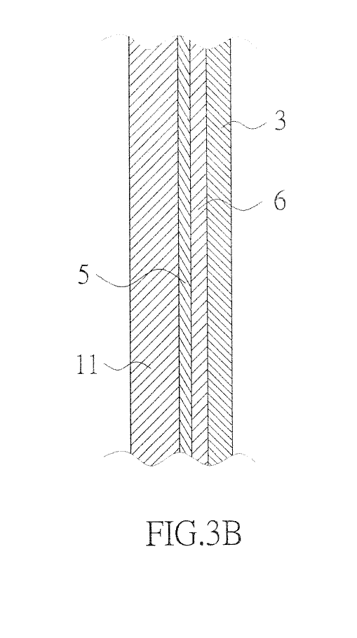

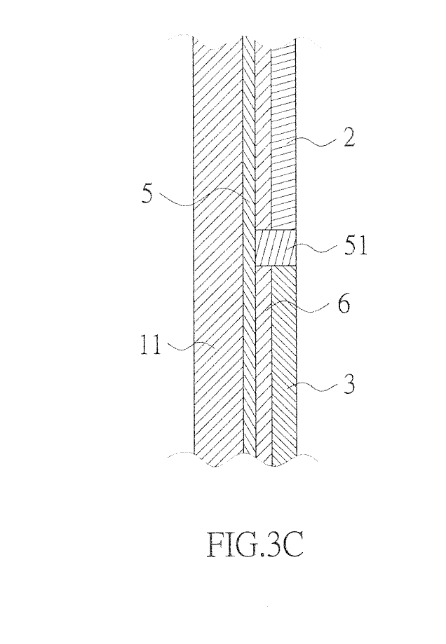

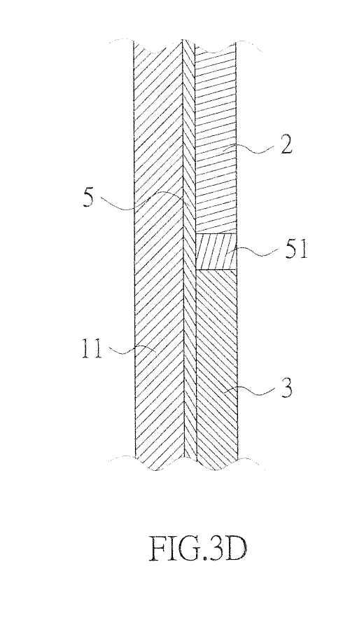

With reference to FIGS. 2 and 3A, the apparatus of the invention shows the first anodic layer 2 coated on the outer surface of the hull 11. The first anodic layer 2 is made of metal-mixed oxide (MMO), which can be, but not limited to, ruthenium-doped titanium oxide, or manganese-mixed titanium oxide, or titanium oxynitride, or bismuth-mixed titanium oxide. In this embodiment, the ruthenium-doped titanium oxide contains 15 wt. % ruthenium, the manganese-mixed titanium oxide contains more than 15 wt. % manganese, the bismuth-mixed titanium oxide contains more than 15 wt. % bismuth. An insulating layer 5 is provided between the first anodic layer 2 and the hull 11 to avoid electro-chemical corrosion of the hull. The thickness of the insulating layer 5 is 5-30 μm. The insulating layer 5 is made of titanium oxynitride (TiO₂₋ₓNₓ, x<2) or chromium oxide. The insulating layer 5 can be omitted if the hull 11 is made of FRP or wood, which is without the risk of oxidation and corrosion. In case the first anodic layer 2 is used to electrolyte seawater for producing O₂/H₂ gases, a conducting titanium layer 6 should be provided between the insulating layer 5 and the first anodic layer 2.

With reference to FIGS. 2, 3B and 3C, the apparatus of the invention shows the first cathodic layer 3 coated on the outer surface of the hull 11. The first cathodic layer 3 can be made of, but not limited to, titanium oxide doped with graphite. An electrically insulating filling 51 is applied between the first anodic layer 2 and the first cathodic layer 3. An electrically insulating layer 5 should be provided between the first cathodic layer 3 and the hull 11 to keep the hull 11 from electro-chemical corrosion. The insulating layer 5 can be omitted if the hull 11 is made of FRP or wood, which is without the risk of oxidation and corrosion. A conducting titanium layer 6 is coated underneath the first anodic layer 2 and the first cathodic layer 3 (FIG. 3C) as a three-layered electro-catalyst. Alternatively, the electrically insulating layer 5 is directly coated underneath the first anodic layer 2 and the first cathodic layer 3 which form the two-layered apparatus of electro-catalysis, as shown in FIG. 3D.

With reference to FIG. 2, the apparatus of the invention shows a DC power supply unit 4 connected to the first anodic layer 2 and the first cathodic layer 3. In case a titanium layer 6 is used, the DC power supply unit 4 is connected to the titanium layer 6. Preferably, the DC power supply unit 4 is equipped with a reference electrode, commonly known as the saturated camel electrode (SCE) 7. By using the reference electrode 7 to manipulate the external DC voltage, the quality of electro-catalysis or electro-catalytic oxidation can be assured. When the DC power supply unit 4 is activated, the electrical power passes through the first anodic layer 2, seawater and the first cathodic layer 3, forming a conducting path for seawater electro-catalysis. In this case, the first anodic layer 2 produces oxygen and the first cathodic layer 3 produces hydrogen. These gases move with the flow of seawater or the movement of the ship, forming a thin gas film or hydrophobic surface on the hull 11.

The diameters of the hydrogen and oxygen bubbles generated by electro-catalysis are much smaller than those produced by prior art. Unlike the compressed air bubbles that are delivered with a significant speed, the gas bubbles are generated with negligible speed. As a result, the gas bubbles stay longer in the boundary layer and enhance the friction reduction effect.

When the ship B is in a harbor or sails with low speeds, i.e., less than 5 knots, the DC power supply unit 4 can reduce its output bias to 0.5-0.7 V vs. the SCE so that the first anodic layer 2 and the first cathodic layer 3 produce hydroxyl radicals, which have strong oxidizing effect and kill marine creatures or plankton adhered to the hull 11, and in this way the risk of biofouling and biocorrosion is reduced.

The invention brings forth two achievements: (1) Biofouling and biocorrosion can be prevented without the use of any conventional protective paint, nor is it necessary to install a conventional sacrificial anode (such as a zinc plate or an aluminum plate) or a conventionally impressed current cathodic protection (ICCP). (2) The frictional resistance of sailing is reduced due to the generation of O₂/H₂ gases through seawater electro-catalysis.

As regard to the first achievement alone, the area covered by the first cathodic layer 3 is smaller than the area covered by the first anodic layer 2. This limits the hydrogen gas yield in a confined area, which prevents the hull 11 from hydrogen brittlement, and reduces the material cost of the first cathodic layer 3, which is made of precious noble metals. The area ratio of the first cathodic layer 3 to the first anodic layer 2 should be in the range between 1:100 and 5:100. A second anodic layer and a second cathodic layer, along with a second DC power supply unit, can be installed on duplicate sections (C and D) of the hull 11. This reduces the total electrical resistance in the electro-catalytic layers in each section. For a better effect the first cathodic layer 3 and the second cathodic layer can be coated on the sea chest B1 or the second sea chest B2 and B3 of the ship B.

As regard to the second achievement, the area covered by the first anodic layer 2 is essentially equal to the area covered by the first cathodic layer 3. The first anodic layer 2 and the first cathodic layer 3 are only located on the flat hull (i.e., not on the curved hull adjacent to the bow or the stern). This enhances the friction reduction effect and also reduces the material cost. The curved hulls are then coated with two-layered electro-catalysts (shown in FIG. 3D) which can fulfill the first achievement, i.e., no seawater electro-catalysis for the generation of O₂/H₂ gases, for lowering the installation cost. An electrically conductive layer 6 is coated underneath the first anodic layer 2 and the first cathodic layer 3 (a three-layered electro-catalyst shown in FIG. 3C), respectively, to enhance the electro-catalytic ability. A second anodic layer and a second cathodic layer, along with a second DC power supply unit, can be installed on duplicate sections C and D of the hull 11. This reduces the total electrical resistance in the electro-catalytic layers in each section.

Considering a current density of about 2 A/m² and the material cost, the hull 11 is preferably divided into different sections (C and D) of coated layers according to different implementations of the above-mentioned achievements. For example, the first anodic layer 2 and the first cathodic layer 3 can be located in the section C, while the second anodic layer and the second cathodic layer can be located in the section D. These layered electro-catalysts are controlled by the corresponding DC power supply units. A possible arrangement is that the first anodic layer 2 and the first cathodic layer 3 are used for biofouling prevention. i.e., the first achievement, while the second anodic layer and the second cathodic layer are used for friction reduction. The layer-covered area for biofouling prevention should be larger than the layer-covered area for friction reduction, because the material cost and the current density of the latter are higher than those of the former. The area ratio of the second anodic layer to the first anodic layer 2 is preferably in the range between 5:100 and 15:100.

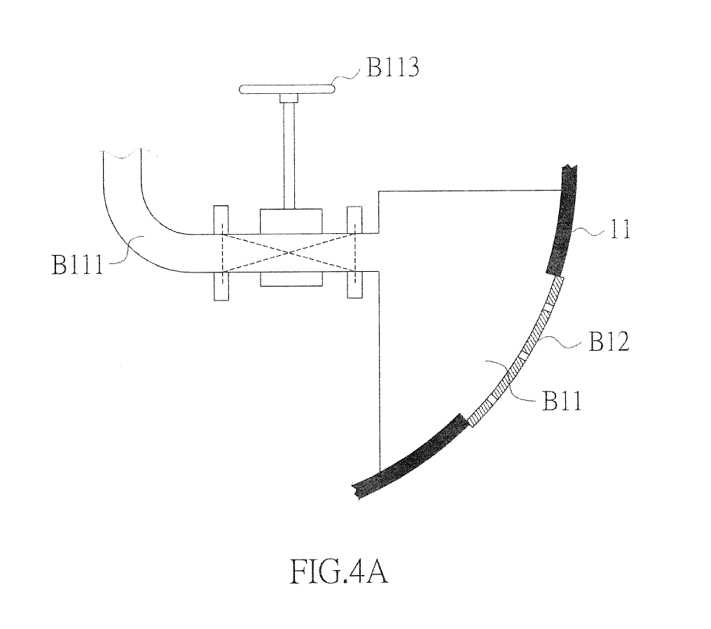

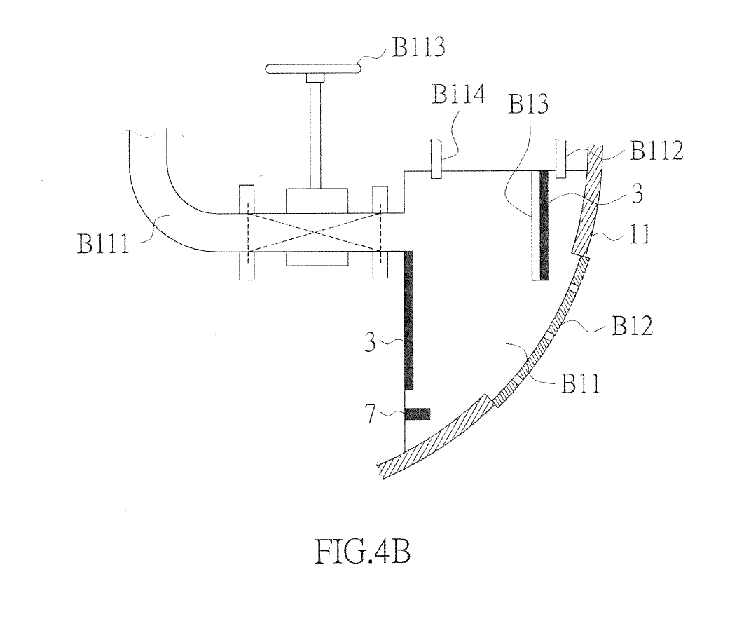

For the sole purpose of biofouling prevention, the first anodic layer 2 can be coated between the propeller and the hull 11 on the starboard or port side, while the first cathodic layer 3 can be located in the first sea chest B1 of the ship B as shown in FIG. 4B. To balance the corrosion potential of the propeller and the rudder, the applied DC current between the first anodic layer 2 and the first cathodic layer 3 can be controlled accurately through the reference electrode SCE 7.

For better performance the first anodic layer 2 can be made of ruthenium-doped titanium oxide with 5 wt. %-15 wt. % ruthenium. A higher value of the ruthenium content enhances the electro-catalytic activity and thus enhances friction reduction. Chlorine and hydrogen can be produced if the applied DC voltage provided by the first DC power supply unit 4 is 1.3 V-1.5 V vs. the SCE. Alternatively, a lower value of the ruthenium content enhances biofouling prevention. The applied DC potential is preferably 0.6 V-0.9 V vs. the SCE. The ruthenium-doped titanium oxide is a better anti-corrosion oxide in seawater. Other materials for anti-corrosion in seawater include titanium-tin oxide, titanium-antimony-tin oxide, titanium-indium-tin oxide, and titanium-nickel oxide.

The present invention regarding biofouling prevention is based on electrolyzing seawater to produce hydrogen and oxygen, or hydrogen and chlorine. First, a layer of titanium oxynitride (TiO₂₋ₓNₓ, x<2) of thickness 5-30 μm is applied on the outer surface of the hull 11 to form the insulating layer 5. Next, a layer of titanium of thickness 100-300 μm is applied on the insulating layer 5 to form the electrical conductive layer 6. Then, a layer of ruthenium-doped titanium of thickness 10-100 μm is applied on the electrical conductive layer 6 as the first anodic layer 2. There is an electrical insulating filling 51 separating the first anodic layer 2 and the first cathodic layer 3. These layers form the three-layered apparatus of electro-catalysis, as shown in FIG. 3C.

If the first anodic layer 2 is made of titanium oxide mixed with manganese, to achieve a desirable effect of biofouling prevention it should have a manganese content of 30 wt. %. The titanium oxide mixed with manganese is a corrosion-resistant oxide in seawater. In practice, a layer of titanium oxynitride (TiO₂₋ₓNₓ, x<2) of thickness 5-30 μm is first applied on the outer surface of the hull 11 to form the insulating layer 5. Next, a layer of an oxide mixed with titanium-manganese ((MnTi)O₂) having a thickness of 10-100 μm is applied on the insulating layer 5 as the first anodic layer 2. There is an electrical insulating filling 51 separating the first anodic layer 2 and the first cathodic layer 3. These layers form the two-layered apparatus of electro-catalysis, as shown in FIG. 3D.

In another embodiment, a layer of titanium oxynitride (TiO₂₋ₓNₓ, x<2) of thickness 5-30 μm is first applied on the outer surface of the hull 11 to form the insulating layer 5. Next, a layer of titanium oxynitride (TiOₓN_{y}, 1.6<x<1.8, 0.1<y<0.3) of thickness 10-100 μm is applied on the insulating layer 5 as the first anodic layer 2. There is an electrical insulating filling 51 separating the first anodic layer 2 and the first cathodic layer 3. These layers form the two-layered apparatus of electro-catalysis without doping with precious metals, as shown in FIG. 3D.

For biofouling prevention the first anodic layer 2 can also be made of titanium oxide mixed with bismuth. In this case the bismuth content in the first anodic layer 2 should be between 25 wt. % and 40 wt. %. Titanium oxide and titanium-tin oxide mixed with bismuth are both corrosion resistant in seawater.

With reference to FIGS. 4A and 4B, several sea chests, B1, B2, B3 and etc. (FIG. 1), are generally installed on the hull 11. Each sea chest consists of a cabinet B11 and a filtering plate B 12. The present invention recommends the arrangement of the sea chest for the first achievement shown in FIG. 4B. The first cathodic layer 3 is mounted on the inner wall of the cabinet B1 or on a fixture B 13 in the cabinet B11. A seawater pipe B111 with a stop valve B 113 is installed in the cabinet B11 to serve as an inlet for cooling seawater. A by-pass pipe B114 is also installed in the cabinet B11 toward to the near-by hull 11. The by-pass pipe B114 maintains a normal pH value of the seawater in the cabinet B11 in the course of electro-catalysis. Hydrogen and hydrogen ions produced by the first cathodic layer 3 can be discharged out of the ship B via the discharge pipe B112 to avoid brittlement of the hull 11.

In summary, the invention can (1) produce oxygen and hydrogen gases so that the outer surface of the hull 11 is covered by a large quantity of micro-bubbles to achieve friction reduction, and (2) provide electro-catalytic oxidation for biofouling prevention, (without using conventional antifouling paint, sacrificial anodes, and ICCP). Thus, the invention saves energy and is environmentally friendly.

Although specific embodiments have been illustrated and described, numerous variations are possible based on the essential ideas of the invention. The scope of the invention is limited by the accompanying claims.

1. A combination comprising:
a submerged portion of a carrier having an outer surface;
an anodic layer coated on the outer surface of the submerged portion;
a cathodic layer coated on the outer surface of the submerged portion and spaced apart from the anodic layer; and
a DC power supply unit connected to the anodic and the cathodic layer.
The anodic layer, the cathodic layer, the DC power supply unit, and the surrounding water form a conducting path for the electro-catalysis of water.

2. The combination, as claimed in claim 1, with the submerged portion of the carrier being the hull of a ship below the water level.

3. The combination, as claimed in claim 2, with the anodic layer and the cathodic layer coated on the outer surface of the hull.

4. The combination, as claimed in claim 3, with the area covered by the anodic layer larger than the area covered by the cathodic layer.

5. The combination, as claimed in claim 3, further comprising: a second anodic layer coated on the outer surface of the hull; a second cathodic layer coated on the outer surface of the hull; and a second DC power supply unit connected to the second anodic layer and the second cathodic layer.

6. The combination, as claimed in claim 5, with the total area covered by the second anodic and cathodic layer smaller than the area covered by the first cathodic and cathodic layer for fulfilling the biofouling prevention.

7. The combination, as claimed in claim 1, with the DC power supply unit connected to a reference electrode.

8. The combination, as claimed in claim 2, with the hull including an opening, with the opening adapted to be in communication with the cabinet of a sea chest of the ship, with the cathodic layer mounted to the inner wall of the cabinet or on a board in the cabinet.

9. The combination, as claimed in claim 2, further comprising: an electrically conductive layer between the anodic layer and the insulating layer; and an electrically conductive layer between the cathodic layer and the insulating layer.

10. The combination, as claimed in claim 2, further comprising: an insulating layer between the anodic layer and the hull; and an insulating layer between the cathodic layer and the hull.

11. A layered coating on the outer surface of a submerged portion of a carrier and adapted to act as an anode, being made of a material selected from the group including oxide doped with ruthenium, oxide mixed with manganese, titanium oxynitride, and oxide mixed with bismuth.

12. The layered coating, as claimed in claim 11, with the layer made of an oxide doped with ruthenium, and with the oxide selected from the group including titanium-tin oxide, titanium-antimony-tin oxide, titanium-indium-tin oxide, and titanium-nickel oxide.

13. The layered coating, as claimed in claim 12, with the layer containing 5 wt. %-15 wt. % ruthenium.

14. The layered coating, as claimed in claim 11, with the layer made of an oxide mixed with manganese, with the oxide selected from the group including titanium oxide and titanium oxynitride.

15. The layered coating, as claimed in claim 14, with the layer containing 30 wt. % manganese.

16. The layered coating, as claimed in claim 11, with the layer made of an oxide mixed with bismuth, with the oxide selected from the group including titanium oxide and titanium-tin oxide.

17. The layered coating, as claimed in claim 16, with the layer containing 25 wt. %-40 wt. % titanium.

18. The layered coating, as claimed in claim 11, with the layer including an inner face facing the outer surface of the submerged portion of the carrier, with an insulating layer provided on the inner face of the layer.

19. The layered coating, as claimed in claim 18, with an insulating layer of thickness 5-30 μm, with the insulating layer made of a material selected from the group including titanium oxynitride and chromium oxide.

20. The layered coating, as claimed in claim 18, further comprises: a titanium layer between the electro-catalytic layer and the insulating layer.
